(19) United States
(12) Patent Application Publication
(10) Pub. No.: US 2024/0086814 A1
(43) Pub. Date: Mar. 14, 2024

(54) SYSTEM AND METHOD FOR PREDICTIVE AUDIT RISK ASSESSMENT

(71) Applicant: Innopiphany, LLC, Irvine, CA (US)

(72) Inventors: Lisa Marie Kennedy, Irvine, CA (US); Junko Hoshi Saber, Irvine, CA (US); Susan Paulvir Haynie, Irvine, CA (US); Katarina Khalatian Bethel, Irvine, CA (US)

(21) Appl. No.: 17/930,846

(22) Filed: Sep. 9, 2022

(51) Int. Cl. G06Q 10/06; G06N 5/02

(52) U.S. Cl. CPC G06Q 10/0635; G06N 5/022

(57) ABSTRACT

A predictive audit risk assessment of a candidate item includes a neural network trained on a plurality of primary source data sets and a plurality of secondary source data sets aggregated into a plurality of training items, each of which may be defined by one or more training item parameters and pre-categorized as an audited status, a comparator status, or unaudited status. The neural network generates a primary audit risk probability numeric value from the candidate item. A clustering analyzer categorizes the training items into one or more clusters based upon the primary source training item parameters and associated pre-categorized status. The clustering analyzer is receptive to the candidate item to identify membership in one of the one or more cluster with a validating nearest-neighbor analysis from a similarity comparison of the one or more parameters associated with the candidate item.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to machine learning systems and neural networks for data analytics, and more particularly to systems and methods for predictive audit risk assessment.

### 2. Related Art

Rapid advancements in pharmaceutical technology have led to the availability of treatments for patients suffering from a wide range of conditions and diseases. The process for developing drugs and biologics is highly complex and involves multiple phases including the discovery and development phase, the clinical research phase, the regulatory review phase, and post-market drug safety monitoring phase, all of which are costly and time intensive.

During the discovery phase, research may be conducted into a target disease or infection and its operating mechanisms, with the identification of potential compounds that may have therapeutic properties against the same. Once a candidate compound is identified, its absorption, metabolization, and other physiological effects may be researched, along with identifying potential side effects or adverse reactions depending on patient characteristics. Interactions with other drugs and treatments may also be researched. In the pre-clinical research phase, in vitro and in vivo studies of the candidate compound are conducted to assess the safety, toxicity, pharmacokinetics, and metabolism thereof. Pharmaceutical research also extends to biologic drugs that are produced from living organisms or contain components of living organisms, including vaccines, blood components, somatic cells, genes, tissues, recombinant proteins, and so forth, though the research or discovery process is similar to conventional chemically synthesized drugs.

Following a successful pre-clinical phase where basic safety questions are addressed, the drug development process proceeds to the clinical research phase in which interactions with the human body are studied. There are four phases, including a first phase that involves anywhere between twenty to one hundred volunteers who are either healthy or have been diagnosed with the target disease, with the primary objective being the determination of safety and dosage. In the second phase, the number of participants may be increased up to several hundred people, and the efficacy and side effects are determined. This phase may take several months up to multiple years. Next, in the third phase that may take another multiple number of years, a thousand or more volunteers may be involved to research efficacy and monitoring of adverse reactions. In the fourth phase, thousands of additional volunteer research subjects may be involved to study the efficacy and side effects. Prior to initiating the clinical study, the federal Food and Drug Administration (FDA) reviews and approves the Investigational New Drug application submitted by the drug developer.

Once the clinical research is completed, the process moves to the regulatory approval phase, in which the FDA reviews the pre-clinical and clinical research data and analysis submitted in a new drug application. Furthermore, inspections are conducted of clinical study sites to ensure the integrity of the data submitted. Generally, the FDA review process is for determining that a drug has been shown to be safe and effective for its intended use. Following this broad determination, the drug manufacturer may cooperate with the FDA to develop and refine prescribing/labeling information. After the FDA approval, the safety and efficacy of the drug is continually monitored in a fifth phase. All approved drugs are publicly listed in the FDA publication, Approved Drug Products with Therapeutic Equivalence Evaluations, also known as the Orange Book. Likewise, approved biologics are publicly listed in the FDA Database of Licensed Biological Products, also known as the Purple Book. In addition to the listing of the approved drugs/biologics, the Orange Book and the Purple Book both provide therapeutic equivalence/biosimilar or interchangeable product evaluations and patents purported to cover the drug/biologic.

The foregoing represents the formal regulatory process for approving a new drug or biologic. Beyond this process, the promotion/marketing, distribution, sale, and payment involves yet another set of interrelated market participants that introduce further complications in delivering the pharmaceutical product from the manufacturer to the patient. These include wholesalers, pharmacies, hospitals, clinics, physician offices, pharmacy benefit managers/health plans, and insurers. The pricing of pharmaceutical products is typically negotiated between pharmaceutical companies and payers, e.g., Medicaid agencies, Department of Veteran's Affairs, and private insurers and pharmacy benefit managers.

Separate from the pharmaceutical companies and the payers, the process of determining pricing and insurance coverage may be further informed by reviews performed by the Institute for Clinical and Economic Review (ICER), an independent non-profit research organization. A fundamental reality is that healthcare resources are not unlimited, and some tradeoffs in organizing and paying for medical treatments, pharmaceutical or otherwise, are necessary. In this context, ICER reviews and evaluates the clinical and economic value of prescription drugs, typically around the time of FDA approval. Among other considerations, quality-adjusted life year (QALY) and equal value of life years gained (evLYG) calculations are used to determine a fair price as well as fair access to the drug being evaluated. Although not all new drugs coming to market are subject to an ICER review, the pharmaceutical company manufacturing a drug that has been selected for one may incur substantial costs in preparing for the review. The details of the ICER review process are widely available and publicly known, but the manner in which a decision is made to subject a given pharmaceutical product to the review is unclear.

Accordingly, as part of the development process, there is a need for drugmakers to understand and prepare for the possibility of an ICER assessment. The likelihood of being subject to an ICER assessment may be the basis for redirecting the research and development, HEOR (Health Economics and Outcome Research), and pricing department efforts or to counsel a more robust analysis with further data collection efforts during the clinical study phase that will support the manufacturer's pricing position. Beyond the context of determining the likelihood of an ICER review, there is a need in the art for machine learning systems and data analytics neural networks that can predictively assess audit risk generally.

### BRIEF SUMMARY

According to one embodiment of the present disclosure, there may be a system for predictive audit risk assessment of a candidate item with one or more associated parameters. The system may include a neural network that is trained on a plurality of primary source data sets and a plurality of secondary source data sets. The primary source data sets and the secondary source data sets may be aggregated into a plurality of training items, each of which may be defined by one or more primary source training item parameters and one or more secondary source training item parameters. The training items may each be pre-categorized as one of an audited status, a comparator status, or unaudited status. The neural network may be receptive to the one or more candidate parameters associated with the candidate item. The neural network may generate in response to the candidate item/candidate parameters a primary audit risk probability numeric value. The system may also include a clustering analyzer that categorizes the training items into one or more clusters based upon the primary source training item parameters thereof and associated pre-categorized status. The clustering analyzer may be receptive to the candidate item to identify membership in one of the one or more cluster with a nearest-neighbor analysis from a similarity comparison of the one or more parameters associated with the candidate item. There may also be an analysis aggregator that is in communication with the neural network and the clustering analyzer. The analysis aggregator may output an overall audit risk probability from a combination of the primary audit risk probability numeric value and the cluster to which the candidate item was assigned.

Another embodiment of the present disclosure may be a method for predictive audit risk assessment of a candidate item with one or more associated parameters. The method may include a step of receiving the one or more associated parameters of the candidate item. There may also be a step of generating a primary audit risk probability numeric value with a neural network. The neural network may be trained on a plurality of primary source data sets and a plurality of secondary source data sets. The primary source data sets and the secondary source data sets may be aggregated into a plurality of training items, each of which may be defined by one or more primary source training item parameters and one or more secondary source training item parameters. The training items may also be pre-categorized as one of an audited status, a comparator status, or unaudited status. The method may include independently assigning the candidate item to one of a plurality of clusters based upon a nearest-neighbor analysis thereto with the one or more candidate parameters associated with the candidate item. Each of the clusters may be based upon a categorization of the training items into the clusters from the primary training item parameters and associated pre-categorized status thereof. The method may also include aggregating the primary audit risk probability numeric value and cluster membership of the candidate item as an overall audit risk probability. This method may be implemented on a non-transitory data storage medium as a series of instructions that are executed by a data processing apparatus to perform such method.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a system for predictive audit risk assessment in accordance with one embodiment of the present disclosure;

FIG. 2A is a table summarizing the predicted scores of the neural network model according to one exemplary embodiment;

FIG. 2B is a table showing the error rate of the neural network model;

FIG. 3 is a table showing an exemplary clustering of training items;

FIG. 4 is a flowchart of a method for predictive audit risk assessment in accordance with another embodiment of the present disclosure; and

FIG. 5 is a detailed block diagram of the system for predictive audit risk assessment.

### DETAILED DESCRIPTION

The present disclosure contemplates various embodiments of systems and methods for predictive audit risk assessment. The detailed description set forth below in connection with the appended drawings is intended as a description of the several presently contemplated embodiments and is not intended to represent the only form in which such embodiments may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

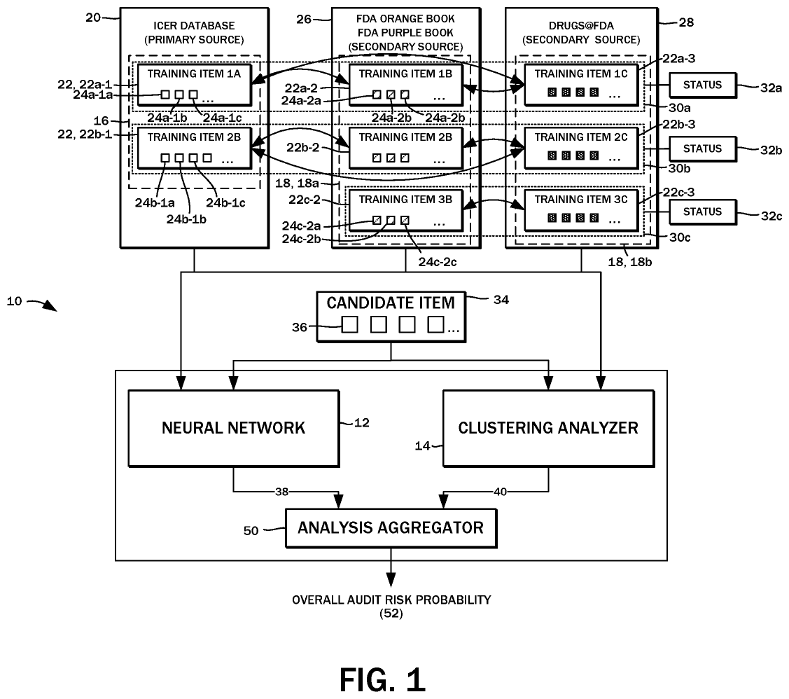

Referring to the block diagram of FIG. 1, one embodiment of the present disclosure contemplates a system for predictive audit risk assessment 10. According to this embodiment, the audit risk assessment may be for evaluating the risk of a new drug product being subject to a secondary review by the Institute for Clinical and Economic Review (ICER). In one embodiment, the secondary review is understood to refer to ICER assessment that is secondary to the primary review for safety and efficaciousness. It is also understood that ICER may undertake a further follow-up review after FDA approval, or an initial ICER assessment, and so the term secondary review may encompass such additional assessments. The various components of the system 10, along with the methods for predictive audit risk assessment will be described in such general context of drug development, and specifically in relation to assessing the risk of a potential ICER audit. Again, while the methodologies employed in the ICER assessment are well-established and known because its reports are published and hence publicly available, the process by which a new drug is selected for an audit are not clear. As described earlier, an ICER assessment may take place concurrently with the final stages of an FDA approval (clinical phase), or shortly after FDA approval as the pharmaceutical company and the various payers negotiate pricing for the drug. On a general level, the embodiments of the present disclosure are contemplated to determine the likelihood of an ICER assessment, though it is deemed to be within the purview of those having ordinary skill in the art to adapt the system 10 to other contexts in which an audit or other costly assessment may be initiated based upon the disclosed components and features.

The system 10 includes a neural network 12, as well as a clustering analyzer 14 that together generate an audit risk assessment as will be described in further detail below. These components and others of the system 10 may be implemented on a data processing apparatus that can be configured to execute pre-programmed instructions that are stored in a data storage device. The components may be implemented atop a data analytics platform such as Alteryx® that provides the basic modules for training and running the neural network 12 as well as the clustering analyzer 14. As will be recognized by those having ordinary skill in the art, the data analytics platform may be a standalone application that is executed on a desktop-class or workstation computer system. Furthermore, the data analytics platform may be a cloud-based system on which various features thereof are provided from a remote computer system or multiple remote computer systems that are connectible via the Internet or other wide or local area networking modality. Other data analytics platforms are known in the art and are readily substitutable. Employing such a data analytics platform may eliminate the need to develop a standalone machine learning/data analytics application, though other embodiments of the present disclosure may encompass such implementations.

The neural network 12 may be trained on a plurality of primary source data sets 16 and a plurality of secondary source data sets 18. According to one embodiment, the primary source data sets 16 are in a database specifically for ICER-assessed drugs, shown in the block diagram of FIG. 1 as ICER database 20. The primary source data sets 16 individually correspond to a training item 22, with the exemplary representation of the ICER database 20 including a first training item 22a-1 and a second training item 22b-1. In turn, each of the training items 22-1 are defined by one or more primary source training item parameters 24-1. For example, the first training item 22a-1 may include a first primary source training item parameter 24a-1a, a second primary source training item parameter 24a-1b, a third primary source training item parameter 24a-1c, and so on. Further, the second training item 22b-1 may include a first primary source training item parameter 24b-1a, a second primary source training item parameter 24b-1b, a third primary source training item parameter 24b-1c, and so on. These primary source training item parameters 24 may include information such as the commercial product name, active ingredient(s), the condition/disease treated by the drug, and so on.

Each training item 22-1 thus corresponds to one drug and the data sets 16 in the ICER database 20 are understood to be for those drugs that have been previously assessed by ICER, either as a directly assessed or audited drug, or as a comparator included in a prior ICER assessment. A comparator drug is that which is currently utilized to treat patients for a particular condition in accordance with defined standards of care. For purposes of illustrative example, the first training item 22a-1 may be such a drug that has been directly assessed by ICER, whereas the second training item 22b-1 may be a drug that has only been included in an ICER assessment as a comparator. Because an ICER assessment addresses economic factors associated with a drug, the primary source training item parameters 24 may additionally include pricing and other economic benefit data such as quality of life-years (QALY) and equal value of life years gained (evLYG) that are specific to such assessments.

There may be multiple secondary sources including the FDA Orange Book/FDA Purple book database 26 as well as the Drugs @FDA (previously known as the AccessFDA) database 28. The secondary source data sets 18a associated with the database 26 may correspond to a first training item 22a-2, a second training item 22b-2, and a third training item 22c-2, each of which represents one drug. Each of the training items 22-2 are defined by one or more secondary source training item parameters 24. For example, the first training item 22a-2 may include a first secondary source training item parameter 24a-2a, a second secondary source training item parameter 24a-2b, a third primary source training item parameter 24a-2c, and so on.

The drug associated with the first training item 22a-1 and the first training item 22a-2 may be the same but have different parameters that are not necessarily common across the ICER database 20 and the FDA Orange Book/FDA Purple Book database 26. However, it will be appreciated that there may be some common or overlapping parameters, as well as at least one key parameter that links the first training item 22a-1 with the first training item 22a-2.

In one embodiment of the present disclosure, the FDA Orange Book/FDA Purple Book database 26 may be produced from multiple data files, including one specific to products, another one specific to patent coverage, and another one specific to exclusivity information.

The product data file may include one field for the active ingredient(s) for the product, one field for the product dosage form and route, as well as one field for the trade name of the product as shown on the labeling. Additionally, there may be a field for the applicant, that is, the firm holding the legal responsibility for the new drug application. Separate fields may provide abbreviated names and full names. There may also be a field for the strength or potency of the active ingredient. The type of new drug application approval may be specified in another field, where the type may be an innovator/New Drug Application, or a generic/Abbreviated New Drug Application. The application number assigned by the FDA may also be specified in a separate field. Each drug is identified by product number, and because each strength or other variation of the same drug is considered a separate product, another field may indicate a specific product number. Along these lines, a therapeutic equivalent (TE) code may be specified in yet another field, indicating the therapeutic equivalence rating of generic to innovator drug products. The date on which the FDA granted approval for the drug may be set forth in a separate field. If a drug has been approved under section 505(c) of the Food, Drug and Cosmetics Act and the FDA has made a finding of safety and effectiveness, the status of the drug as Reference Listed Drug may be included. A field identifying the Reference Standard drug that has been selected by the FDA that an applicant seeking approval of a generic drug (applied as an ANDA) must use for its in vivo bioequivalence study may also be included. Lastly, the products data may include a field for the category of approved drugs, whether it is prescribed (Rx), over the counter (OTC), or discontinued (DSCN).

The patent data file may include some overlapping fields with the product data file, including the new drug application type, the new drug application number, and the product number. Additionally, there may be a separate field for the patent number(s) submitted by the applicant that purport to cover drug, along with its expiration date. There may be a flag/field for indicating that the patent claims the drug substance, a flag/field for indicating that the patent claims the drug product, and a flag/field for indicating that the patent claims an approved indication or use of a drug product. Furthermore, there may be a field/flag for when a request that a patent be delisted has been received. There may also be a field for the date on which the FDA receives the patent information from the NDA holder.

The exclusivity data file may include a few of the same overlapping fields as the patent data file and the product data file such as the new drug application type, the new drug application number, and the product number. Additionally, the exclusivity code assigned by the FDA may be specified in another field, as well as the expiration date of the exclusivity.

Information pertaining to other FDA approval routes such as through the orphan drugs designation and breakthrough therapy designations may also be included in a different secondary data source. General Data Fields such as prevalence of the treated condition, average age of diagnosis, social sentiment, and clinical trial information may be incorporated therein.

Notwithstanding the foregoing enumeration of the possible data fields of the Orange Book and Purple Book data as provided by the FDA, not all fields need be utilized. Some fields may not be pertinent and hence may be removed.

The second training item 22b-2 is likewise understood to be for the same drug as the second training item 22b-1, with various parameters that will not be specifically mentioned for the sake of brevity. The third training item 22c-2 in the FDA Orange Book/FDA Purple Book database 26 may be for a drug that has not been subject to an ICER assessment, hence there is no equivalent training item in the ICER database 20. Similar to the other training items, the third training item 22c-2 includes one or more secondary source training item parameters 24. For example, there may be a first secondary source training item parameter 24c-2a, a second secondary source training item parameter 24c-2b, a third primary source training item parameter 24c-2c, and so on.

As indicated above, there may be multiple secondary sources. Another secondary source may be the Drugs @ FDA database 28, which shares some overlapping information with the FDA Orange Book/FDA Purple Book database 26. However, information such as tentative approvals and Type 6 approvals, therapeutically equivalent products, over-the-counter drugs containing the same active ingredient, strength, dosage form, and administration route, and so on may be included. Beyond the U.S.-centric regulatory reviews described herein, it is expressly contemplated that the techniques of the present disclosure may be adopted to other contexts and rely on different sets of primary and secondary data sources. For example, another application contemplates drug product evaluations in the United Kingdom, where the National Health Service performs similar evaluation functions based on various data points. Such data may be adopted for use in the contemplated system 10. The secondary source data sets 18b associated with the database 28 may correspond to a first training item 22a-3, a second training item 22b-3, and a third training item 22c-3, each of which represents one drug. In this regard, the first training item 22a-1, the first training item 22a-2, and the first training item 22a-3 are understood to correspond to that single drug, though with each training item having different data/parameter dimensions relative to the others with some shared overlap that allows for the linking of all three training items. Similar to the other training items, the training item 22a-3, 22b-3, and 22c-3 associated with the database 28 each have respective training item parameters 24.

The training items 22 for a given drug, each originating from a different data source, may be so grouped into a training item set 30. For example, the training items 22a-1, 22a-2, 22a-3 may be for a drug A, and grouped into a first training item set 30a. The training items 22b-1, 22b-2, 22b-3 may be for a drug B, and grouped into a second training item set 30b. The training items 22c-2 and 22c-3 may be for a drug C and grouped into a third training item set 30c. Each drug, or training item set 30, may be categorized into one of three statuses for purposes of the training data provided to the neural network 12. The first status category is that the drug has been subject to an ICER assessment, and so this may be referred to more generally as an audited status. The second status category is that the drug has been referenced as a comparator in an ICER assessment, which may be referred to more generally as a comparator status. The third status category is that the drug has not been subject to an ICER assessment and may be referred to more generally as an unaudited status.

The status categories may be assigned to a status flag 32 that is generally associated with a corresponding training item set 30. Thus, the first training item set 30a may have a corresponding status flag 32a—continuing with the example from above, the drug corresponding to the training items 22a-1, 22a-2, and 22a-3 is one that had been subject to an ICER assessment, so the status flag 32a may be set to the first status category. Along these lines, the drug corresponding to the training items 22b-1, 22b-2, and 22b-3 as defining a second training item set 30b is one that had been referenced as a comparator in an ICER assessment, so the associated status flag 32b may be set to the second status category. The drug corresponding to the training items 22c-2 and 22c-3 as defining the third training item set 30c is one that had not been subject to an ICER assessment or referenced as a comparator, so the associated status flag 32c may be set to the third status category.

Although the status flags 32 are shown as directly linked or related to the training item sets 30, this is by way of example only and not of limitation. In certain respects, the status flags 32 may be more directly linked to or associated with one or more of the constituent training items 22 of the training item sets 30. The structure and interrelationships between the training items 22, training item parameters 24, the databases 20, 26, 28, are also exemplary only, and any other structure or interrelationship best suited for training the neural network 12 may be utilized.

The neural network 12 receives the training items 22 and its training item parameters 24, along with the associated status flags 32. Based upon this data, the neural network 12 develops a model by which the likelihood of a subsequent candidate item 34 would also be subject to an ICER assessment can be determined. The illustrated embodiment is based upon the ICER database 20, the FDA Orange Book/FDA Purple Book database 26, and the Drugs @FDA database 28, though additional data sources may supplement the training data to the neural network 12.

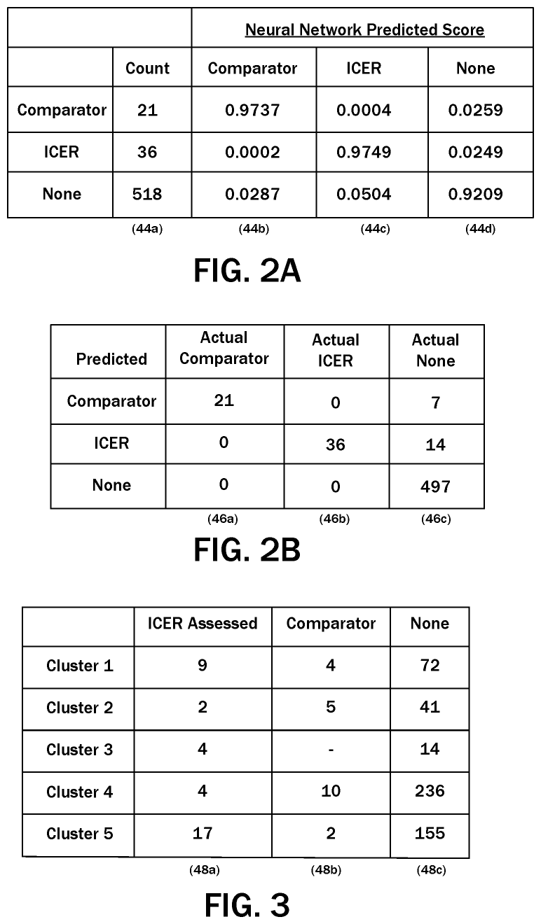

The table of FIG. 2A summarizes the results of an exemplary embodiment of the neural network model, which is built on a total of 575 original records. The first column 42a shows the total number of training items 22 that were flagged as an ICER comparator, an ICER assessment, and none. The second column 42b lists the predicted score for comparator training items 22 in relation to the flagged status. For example, the neural network 12 on average scored a training item 22 flagged as a comparator of 0.9737 or 97% likely as being an ICER comparator product, 0.0002 or 0.2% likely as being an ICER assessed item, and 0.0287 or 2% likely as being flagged as none. The third column 42c lists the predicted score for ICER assessed training items 22 in relation to the flagged status, and the fourth column 42d lists the predicted score for non-flagged/audited training items 22 in relation to the flagged status. The foregoing is being presented as one example of the performance that may be achievable with the system 10. However, it will be appreciated that such results may not be replicable across all possible future inputs. For example, changes in audit strategy by ICER or the market may result in different performance results.

The table of FIG. 2B shows in a first column 46a that the neural network 12 accurately predicted the comparator status for each of the actual twenty-one (21) training items 22 that were flagged as such, and the ICER assessed status for each of the thirty-six (36) training items 22 that were flagged as such. These values are shown in a first column 44a and a second column 44b, respectively. There were a few anomalies, however, with predicting Comparator and ICER assessed status when the actual training item 22 was flagged as none per the count values shown in column 44c. For instance, the neural network 12 according to one embodiment predicted a comparator status seven (7) times when the actual flagged status was none. Furthermore, this neural network predicted an ICER assessed status fourteen (14) times when the actual flagged status was none. These anomalies may be attributable to one or more errors, or may be drug products outside a selected time range, or those that may eventually be assessed.

The candidate item 34, which corresponds to a new drug for which a likelihood of being subject to an audit such as an ICER assessment in accordance with various embodiments of the present disclosure, also includes a set of candidate item parameters 36 that are input to the neural network. The candidate item parameters 36 are understood to be those of the candidate drug that are available, and generally correspond to the training item parameters 24 like orphan designation, prevalence, and age of diagnosis. The neural network 12 generates a primary audit risk probability numeric value 38 from the candidate item 34.

The embodiments of the present disclosure contemplate a dual approach that additionally utilizes the clustering analyzer 14 to determine whether the candidate item 34 fits within one of a plurality of clusters that are likely to include as members those training items 22 that were subject to an ICER assessment. Specifically, the clustering analyzer 14 implements a k-means clustering process, with a preferred, though optional embodiment employing five (5) clusters. This is by way of example only, and any other suitable number of clusters may be utilized without departing from the scope of the present disclosure. The clustering analyzer 14 is understood to categorize the training items 22 into one of the five clusters based upon the training item parameters 24 thereof.

The table of FIG. 3 shows an exemplary grouping of five clusters, a given column in each row corresponding to one cluster listing the number of training items 22 flagged as ICER assessed (column 48a), comparator (column 48b), and none (column 48c).

In further detail, the clustering analyzer 14 defines or establishes the predetermined number of clusters (e.g., five) based upon the constituent data of the training items 22. Those training items 22 that are the closest to the defined boundaries between a given pair of clusters but are still outside the cluster most closely associated with a higher risk of being subjected to the secondary assessment are selected for further evaluation. This nearest-neighbor analysis determines whether those training items 22 are more proximal to membership in the higher risk cluster. Such evaluation may be used for purposes of validating the clustering results, or as a secondary way to identify closer cluster members. The clustering model may be updated from time to time with refined models and additional data from regulatory approvals and the like. From the clustering model, the clustering analyzer may determines whether the candidate item 34 is a member of any one of the clusters from a similarity comparison of the one or more candidate item parameters 36. Upon completion, the clustering analyzer 14 outputs a cluster membership value 40.

Both the primary audit risk probability numeric value 38 and the cluster membership value 40 may be provided to an analysis aggregator 42 that combines the independent risk assessment such values represent. There may be certain circumstances where the primary audit risk probability numeric value 38 is sufficiently high to conclude that the candidate item 34/drug will be subject to an ICER assessment. For example, the neural network 12 may generate a high primary audit risk probability numeric value 38 of 0.805, or 80.5%, so from this alone a high probability of an ICER assessment can be established. However, the neural network 12 may generate a low primary audit risk probability numeric value 38 of 0.000, but the clustering analyzer 14 may determine that the candidate item 34 is a member of cluster 5. As discussed above, this cluster is the dominant one with the most ICER-assessed training items 22. A nearest neighbor analysis may be used to confirm that the candidate item 34 is a member of cluster 5. Under these circumstances, notwithstanding the low primary audit risk probability numeric value 38, the candidate item 34 may be nevertheless concluded to be at risk for an ICER assessment due to the proximity to the most dominant cluster for those training items 22 subject to an ICER assessment. To the extent the nearest neighbors also include less-dominant clusters, the conclusion may be adjusted.

The system 10 may include an analysis aggregator 50 that accepts as inputs the primary audit risk probability numeric value 38 and the cluster membership value 40 to yield an overall audit risk assessment 52.

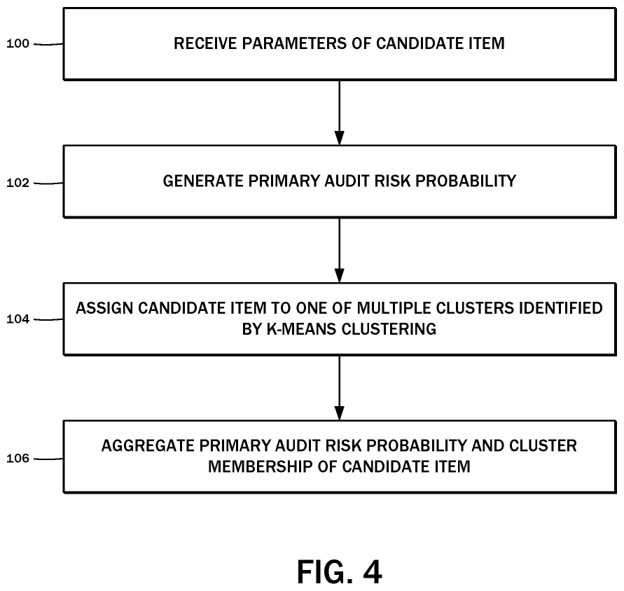

Having considered the overall system 10, referring now to the flowchart of FIG. 4, another embodiment of the present disclosure contemplates a method for predictive audit risk assessment. The method begins with a step 100 of receiving the candidate item parameters 36 of the candidate item 34 as discussed above. The data representative of the candidate item 34 may be provided to both the neural network 12 and the clustering analyzer 14 as discussed above. By the time the system is configured to accept the candidate item 34 and the data pertaining thereto, it is assumed that the neural network 12 has been trained using the training data as discussed above, and the five clusters have already been determined. The method proceeds to a step 102 of generating the primary audit risk probability numeric value 38, which is performed by the neural network 12. The method also includes a step 104 of assigning the candidate item to one of multiple clusters that have been identified by the k-means clustering algorithm implemented by the clustering analyzer 14. The membership in the assigned cluster may be verified by a nearest neighbor analysis. The method may conclude with a step 106 of aggregating the primary audit risk probability numeric value 39 and the cluster membership of the candidate item 34.

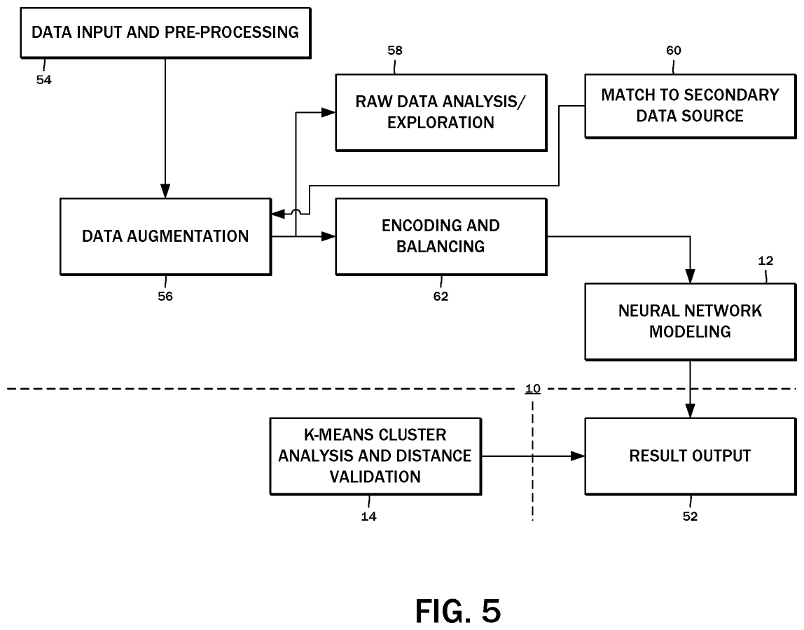

Referring now to the detailed block diagram of FIG. 5, the system 10 may include additional components for preparing the neural network 12. As described more broadly above, the neural network 12 may be trained with a primary data source (e.g., the ICER database 20), and a plurality of secondary data sources (e.g., the FDA Orange Book/FDA Purple Book database 26 and the Drugs @FDA database 28). The structure and format of the data as retrieved from the original sources is not usable by the neural network 12, so additional steps may be performed by different sub-modules of the system 10. Specifically, there may be a data input and pre-processing block 54, which receives the FDA Orange Book information, the Drugs @FDA information, as well as the source information for the ICER database 20 that may be in a tabular format. Each of these data sources may be restructured into a common format, for subsequent processing.

Next, there may be a data augmentation block 56 that retrieves the aggregated data from the data input and pre-processing block 54 and supplements data elements that may be missing from certain sources but available in others. From here, there may be a raw data analysis/exploration block 58 in which a user may manually review the aggregated data. At this stage, the collection of data may correspond to the aforementioned training item 22 that has been organized according to training item sets, with each training item 22 including one or more training item parameter values. There may also be a block 60 for matching the generated data set to another secondary data source, the FDA Purple Book. Before the data is provided to the neural network 12, there may be an encoding and balancing block 62 that re-arranges the raw data collected from the ICER database 20, the FDA Orange Book/FDA Purple Book database 26, and the Drugs @FDA database 28, as well as any other pertinent secondary sources into a format that is recognizable as training data by the neural network 12.

The results of the neural network 12 and the clustering analyzer 14 may then be output in a block 64.

The particulars shown herein are by way of example and for purposes of illustrative discussion of the embodiments of the system and methods for predictive audit risk assessment and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A system for predictive audit risk assessment of a candidate item with one or more associated parameters, the system comprising:
a neural network trained on a plurality of primary source data sets and a plurality of secondary source data sets, the primary source data sets and the secondary source data sets aggregated into a plurality of training items each defined by one or more primary source training item parameters and one or more secondary source training item parameters, the training items each being pre-categorized as one of an audited status, a comparator status, or unaudited status, the neural network being receptive to the one or more candidate parameters associated with the candidate item with a primary audit risk probability numeric value being generated in response;
a clustering analyzer categorizing the training items into one or more clusters based upon the primary source training item parameters thereof and associated pre-categorized status, the clustering analyzer being receptive to the candidate item to identify membership in one of the one or more cluster with a nearest-neighbor analysis from a similarity comparison of the one or more parameters associated with the candidate item; and
an analysis aggregator in communication with the neural network and the clustering analyzer, the analysis aggregator outputting an overall audit risk probability from a combination of the primary audit risk probability numeric value and the cluster to which the candidate item was assigned.

2. The system for predictive audit risk assessment of claim 1, wherein the candidate item and the training items are drug products.

3. The system for predictive audit risk assessment of claim 2, wherein the drug products corresponding to the training items for which the primary training item parameters are in the primary source data sets are those that were previously subject to an audit.

4. The system for predictive audit risk assessment of claim 3, wherein the comparator status indicates that the training item was subject to the audit as a comparator drug.

5. The system for predictive audit risk assessment of claim 3, wherein the audit is a cost and clinical-benefit analysis of the drug product.

6. The system of predictive audit risk assessment of claim 2, wherein the secondary source data set is a listing of drug products approved for marketing in interstate commerce.

7. The system of predictive audit risk assessment of claim 6, wherein the secondary source training item parameters are selected from a group consisting of: regulatory exclusivity data, drug product data, and drug patent coverage data.

8. The system of predictive audit risk assessment of claim 2, wherein the secondary source data set is a listing of drugs for which regulatory approval has been applied.

9. The system of predictive audit risk assessment of claim 8, wherein the secondary source training item parameters is selected from a group consisting of: application summary data, marketing status data, therapeutic equivalents data, and drug product detail data.

10. The system of predictive audit risk assessment of claim 1, wherein the clustering analyzer categorizes the training items with a k-means clustering process.

11. A method for predictive audit risk assessment of a candidate item with one or more associated parameters, the method comprising:
receiving the one or more associated parameters of the candidate item;
generating a primary audit risk probability numeric value with a neural network trained on a plurality of primary source data sets and a plurality of secondary source data sets, the primary source data sets and the secondary source data sets being aggregated into a plurality of training items each defined by one or more primary source training item parameters and one or more secondary source training item parameters, the training items each being pre-categorized as one of an audited status, a comparator status, or unaudited status;
independently assigning the candidate item to one of a plurality of clusters based upon a nearest-neighbor analysis thereto with the one or more candidate parameters associated with the candidate item, each of the clusters being based upon a categorization of the training items into the clusters from the primary training item parameters and associated pre-categorized status thereof; and
aggregating the primary audit risk probability numeric value and cluster membership of the candidate item as an overall audit risk probability.

12. The method for predictive audit risk assessment of claim 11, wherein the candidate item and the training items are drug products.

13. The method for predictive audit risk assessment of claim 12, wherein the drug products corresponding to the training items for which the primary training item parameters are in the primary source data sets are those that were previously subject to an audit.

14. The method for predictive audit risk assessment of claim 13, wherein the comparator status indicates that the training item was subject to the audit as a comparator drug.

15. The method for predictive audit risk assessment of claim 13, wherein the audit is a cost-benefit analysis of the drug product.

16. The method for predictive audit risk assessment of claim 12, wherein the secondary source data set is a listing of drug products approved for sale.

17. The method for predictive audit risk assessment of claim 16, wherein the secondary source training item parameters is selected from a group consisting of: regulatory exclusivity data, drug product data, and drug patent coverage data.

18. The method for predictive audit risk assessment of claim 12, wherein the secondary source data set is a listing of drugs for which regulatory approval has been or will be applied.

19. The method for predictive audit risk assessment of claim 18, wherein the secondary source training item parameters is selected from a group consisting of: application summary data, marketing status data, therapeutic equivalents data, and drug product detail data.

20. The method for predictive audit risk assessment of claim 1, wherein the clustering analyzer categorizes the training items with k-means clustering.

21. The method for predictive audit risk assessment of claim 1, wherein nearest neighbor distance calculation validates the training items with k-means clustering.
